(19) United States
(12) Patent Application Publication
(10) Pub. No.: US 2025/0174808 A1
(43) Pub. Date: May 29, 2025

(54) BATTERY MODULE

(71) Applicant: SAMSUNG SDI CO., LTD., Yongin-si (KR)

(72) Inventors: Hyeok Soo HONG, Yongin-si (KR); Dong Woo KIM, Suwon-si (KR); Seok Joon YOON, Suwon-si (KR)

(21) Appl. No.: 18/796,465

(22) Filed: Aug. 7, 2024

(30) Foreign Application Priority Data
Nov. 27, 2023 (KR) 10-2023-0166826

(51) Int. Cl. H01M 50/317; H01M 10/48; H01M 50/358; H01M 50/383

(52) U.S. Cl. CPC H01M 50/317; H01M 10/482; H01M 50/358; H01M 50/383

(57) ABSTRACT

A battery module is provided wherein pressure deviation inside a battery cell of the battery module is controlled. The battery module includes a housing, a plurality of battery cells disposed inside the housing, and a pressure regulator configured to control an internal pressure of each of the plurality of battery cells.

### CROSS-REFERENCE TO RELATED APPLICATION

The present application claims priority and the benefit of Korean Patent Application No. 10-2023-0166826, filed on Nov. 27, 2023, in the Korean Intellectual Property Office, the entire disclosure of which is incorporated herein by reference.

### BACKGROUND

### 1. Field of the Invention

Aspects of embodiments of the present disclosure relates to a battery module.

### 2. Discussion of Related Art

As the demand for portable electronic products such as laptops, video cameras, and portable phones rapidly increases and robots, electric vehicles, and the like are commercialized in earnest, research on high-performance secondary batteries capable of repeated charging and discharging is actively underway.

Secondary batteries are widely used for driving or storing energy in small devices such as portable electronic devices, as well as medium to large-sized devices such as electric vehicles and energy storage systems (ESS). In the case of medium to large-sized devices, one battery module is constituted by a plurality of battery cells electrically connected to each other to improve output and/or capacity of the battery.

Battery modules in the related art maintain durability by applying a certain level of surface pressure to battery cells through a housing structure installed to surround the battery cells. However, in the housing structure, when a swelling phenomenon in which a battery cell expands due to rapid charging, overcharging, overdischarging, short circuit, or high temperature storage occurs, a pressure deviation occurs inside the battery cell.

The above-described information disclosed in the technology that forms the background of the present disclosure is only intended to improve understanding of the background of the present disclosure, and thus may include information that does not constitute the related art.

### SUMMARY OF THE INVENTION

An aspect of embodiments of the present disclosure is directed to providing a battery module capable of alleviating a pressure deviation due to expansion of a battery cell.

These and other aspects and features of the present disclosure will be described in, or will be apparent from, the following description of some embodiments of the present disclosure.

According to one or more embodiments, a battery module includes: a housing, a plurality of battery cells disposed inside the housing, and a pressure regulator configured to control an internal pressure of each of the plurality of battery cells.

Each of the battery cells may include a can, an electrode assembly disposed inside the can and spaced apart from an inner surface of the can, and a fixed guide supporting the electrode assembly.

According to a first embodiment of the fixed guide, the fixed guide may include a fixed pad attached to an inner wall of the can to support the electrode assembly, with the fixed pad including an elastic material.

According to a second embodiment of the fixed guide, the fixed guide may include a fixed spring mounted on an inner wall of the can and having elasticity, and the fixed guide may include a fixed holder supported by the fixed spring and holding the electrode assembly.

The pressure regulator may include a control line connected to each of the battery cells to control the internal pressures of the battery cells and a supply line connected to the control lines to supply a fluid to the battery cells.

A first embodiment of the control line may include a supply flow path connecting the battery cell and the supply line and configured to supply the fluid to the battery cell, a supply valve formed on the supply flow path and configured to control a supply amount of the fluid, and a storage unit connected to the supply flow path and configured to temporarily store the fluid.

The first embodiment of the control line may further include a discharge flow path connecting the battery cell and supply line and configured to discharge the fluid from the battery cell and a discharge valve formed on the discharge flow path and configured to control a fluid discharge amount.

The first embodiment of the control line may further include a sensor configured to detect the internal pressure of the battery cell and a controller configured to operate the supply valve and the discharge valve according to a detection signal from the sensor.

A second embodiment of the control line may include a supply flow path connecting the battery cell and the supply line and configured to supply the fluid to the battery cell, a supply valve formed on the supply flow path and configured to control a supply amount of the fluid, a main storage unit formed on the supply flow path and configured to temporarily store the fluid, and a sub storage unit formed on the supply flow path, configured to temporarily store the fluid, and disposed between the main storage unit and the supply valve.

The second embodiment of the control line may further include an on-off valve formed on the supply flow path, disposed between the main storage unit and the sub storage unit, and configured to open and close the supply flow path.

The on-off valve may open the supply flow path when a pressure of the fluid stored in the sub storage unit is greater than a pressure of the fluid stored in the main storage unit.

The second embodiment of the control line may further include a discharge flow path connecting the battery cell and the supply line and configured to discharge the fluid from the battery cell and a discharge valve formed on the discharge flow path and configured to control a fluid discharge amount.

The second embodiment of the control line may further include a sensor configured to detect the internal pressure of the battery cell and a controller configured to operate the supply valve and the discharge valve according to a detection signal from the sensor.

A third embodiment of the control line may include a supply flow path connecting the battery cell and the supply line and configured to supply the fluid to the battery cell and a storage unit connected to the supply flow path and configured to temporarily store the fluid.

The third embodiment of the control line may further include a discharge flow path connecting the battery cell and the supply line and configured to discharge the fluid from the battery cell and a discharge valve formed on the discharge flow path and configured to control a fluid discharge amount.

The third embodiment of the control line may further include a sensor configured to detect the internal pressure of the battery cell and a controller configured to operate the discharge valve according to a detection signal from the sensor.

The supply line may include a supply flow path having both of its ends connected to the control line to circulate the fluid, a supply pump formed on the supply flow path and configured to discharge the fluid, and a supply tank formed on the supply flow path and configured to store the fluid.

The supply line may further include a supply cooler formed on the supply flow path and configured to cool the fluid.

The supply line may include a fire detector configured to detect a fire inside the battery module and a fire extinguishing agent supply unit connected to the supply flow path and configured to supply a fire extinguishing agent according to a detection signal from the fire detector.

The supply line may further include a selection valve formed on the supply flow path and configured to selectively supply the fluid provided from the supply tank and the fire extinguishing agent provided from the fire extinguishing agent supply unit to the supply flow path.

According to an embodiment of the present disclosure, a pressure regulator can control the pressure inside a battery cell to provide a uniform pressure to an electrode assembly.

According to an embodiment of the present disclosure, when pressure inside a can is increased by the pressure regulator, a uniform pressure can be applied to the electrode assembly even when the can is deformed.

According to an embodiment of the present disclosure, since the electrode assembly is disposed to be spaced apart from an inner surface of the can by a fixed guide, even when the electrode assembly expands, the separation between the electrode assembly and the can may be maintained, and thus the pressure inside the can may be stably controlled.

According to an embodiment of the present disclosure, a cooler can cool a fluid and the cooled fluid can be introduced into the battery cell, and thus the inside of the battery cell can be cooled.

According to an embodiment of the present disclosure, when a fire detector detects a fire inside the battery module, a fire extinguishing agent supplied from a fire extinguishing agent supply unit can be input into the battery module through a supply flow path to quickly extinguish the fire.

According to an embodiment of the present disclosure, a battery pack manufactured using a battery with an improved structure and a vehicle including the same can be provided.

The effects obtainable through the present disclosure are not limited to the effects described herein, and other technical effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a view schematically illustrating a battery module according to one embodiment of the present disclosure;

FIG. 2 is a view schematically illustrating a battery cell according to one embodiment of the present disclosure;

FIG. 3 is a view schematically illustrating a first embodiment of a fixed guide in FIG. 2;

FIG. 4 is a view schematically illustrating a second embodiment of the fixed guide in FIG. 2;

FIG. 5 is a view schematically illustrating a pressure regulator according to one embodiment of the present disclosure;

FIG. 6 is a view schematically illustrating a first embodiment of a control line in FIG. 5;

FIG. 7 is a view schematically illustrating a second embodiment of the control line in FIG. 5;

FIG. 8 is a view schematically illustrating a third embodiment of the control line in FIG. 5;

FIG. 9 is a view schematically illustrating a supply line according to one embodiment of the present disclosure;

FIG. 10 is a view schematically illustrating a movement path of a fluid in FIG. 9; and

FIG. 11 is a view schematically illustrating a movement path of a fire extinguishing agent in FIG. 9.

### DETAILED DESCRIPTION OF EXEMPLARY EMBODIMENTS

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C; A and B; A and C; B and C; or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

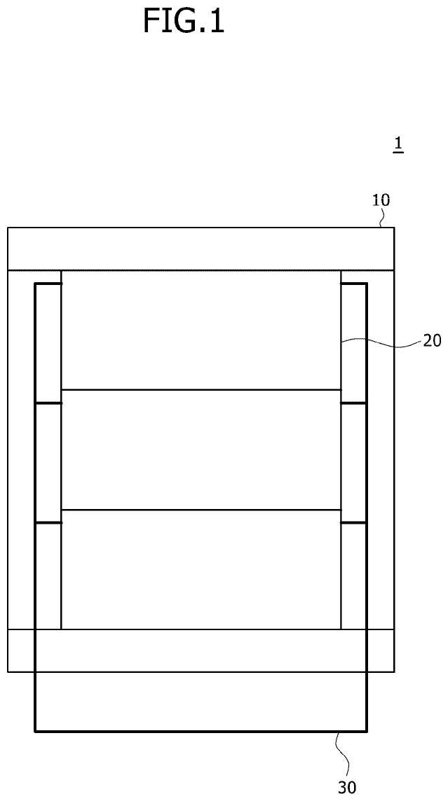

FIG. 1 is a view schematically illustrating a battery module 1 according to one embodiment of the present disclosure. The battery module 1 includes a housing 10, a battery cell 20, and a pressure regulator 30.

The housing 10 may have a frame shape for disposing the battery cell 20 therein. A plurality of battery cells 20 may be arranged in a row. The battery cells 20 may be in close contact with each other or may be spaced apart at a predetermined interval. The battery cell 20 may be a unit structure for storing and supplying power and may be wound with an insulating separator between a positive electrode and a negative electrode.

The pressure regulator 30 may control an internal pressure of each of the plurality of battery cells 20. The pressure regulator 30 may be supplied with a fluid or a fluid may be discharged from the pressure regulator 30 so that the internal pressure of each battery cell 20 is uniformly maintained.

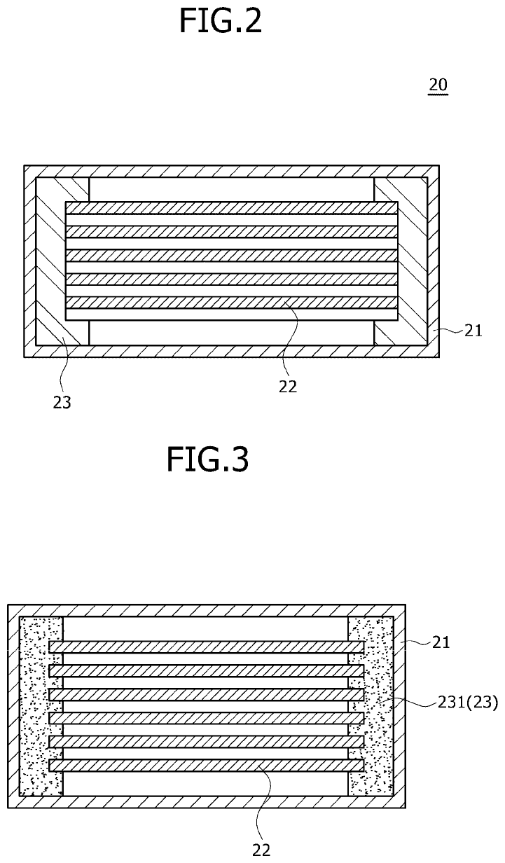

FIG. 2 is a view schematically illustrating a battery cell 20 according to one embodiment of the present disclosure. The battery cell 20 may include a can (enclosure) 21, an electrode assembly 22, and a fixed guide 23.

The can 21 includes a metallic material, and the electrode assembly 22 may be disposed inside the can 21. A plurality of electrode assemblies 22 may be stacked and spaced apart from an inner surface of the can 21.

The fixed guide 23 may support the electrode assembly 22. The fixed guide 23 may be disposed inside the can 21 and coupled to the electrode assembly 22 to maintain a state in which the electrode assembly 22 is spaced apart from the can 21. The fixed guide 23 may support the electrode assembly 22 so that the electrode assembly 22 does not contact the inner surface of the can 21 even if the electrode assembly 22 is expanded.

FIG. 3 is a view schematically illustrating a first embodiment of the fixed guide 23 in FIG. 2. The fixed guide 23 may include a fixed pad 231. The fixed pad 231 may be attached to an inner wall of the can 21 to support the electrode assembly 22 and may include an elastic material. The fixed pad 231 may be disposed on at least one of inner walls of the hexahedrally-shaped can 21. The fixed pad 231 may be attached to the inner wall of the can 21 with an adhesive. The fixed pad 231 may extend in a longitudinal direction of the inner wall of the can 21. One fixed pad 231 may support a plurality of electrode assemblies 22 at the same time. The fixed pad 231 may be formed of rubber or an elastic material capable restoring its shape after contraction.

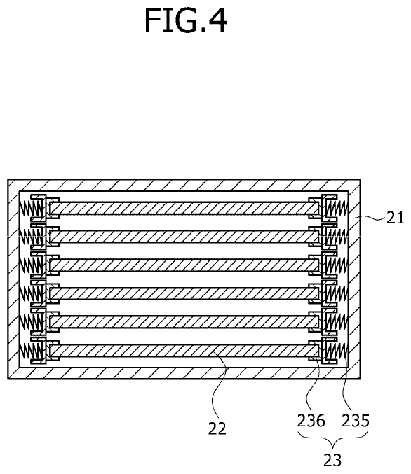

FIG. 4 is a view schematically illustrating a second embodiment of the fixed guide in FIG. 2. In this embodiment, the fixed guide 23 may include a fixed spring 235 and a fixed holder 236.

The fixed spring 235 may be mounted on the inner wall of the can 21 and may have the shape of an elastic coil spring. Fixed springs 235 may be disposed to correspond to each electrode assembly 22.

The fixed holder 236 may be supported by the fixed spring 235 and may hold the electrode assembly 22. The fixed holder 236 may be coupled to each electrode assembly 22 and supported by the fixed spring 235 to maintain the state in which the electrode assembly 22 is spaced apart from the inner wall of the can 21.

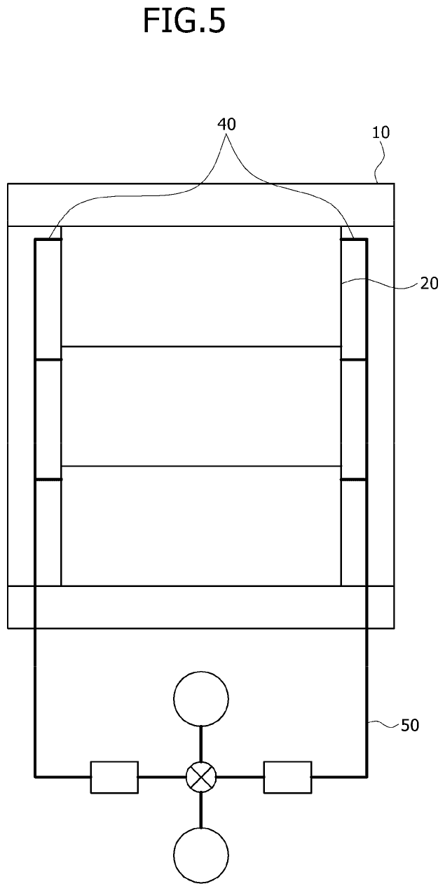

FIG. 5 is a view schematically illustrating a pressure regulator 50 according to one embodiment of the present disclosure. The pressure regulator 30 may include a control line 40 and a supply line 50.

The control line 40 is connected to each battery cell 20 to control the internal pressure of the battery cells 20. The inside of each battery cell 20 may be maintained at a set pressure by the control line 40. When the inside of the battery cell 20 is maintained at the set pressure, external deformation of the can 21 may be suppressed even when an electrode assembly 22 in the battery cell 20 expands.

The supply line 50 may be connected to the control line 40 to supply a fluid. The control line 40 is connected to both left and right sides of the battery cell 20, and both ends of the supply line 50 may be connected to the control line 40. The supply line 50 may supply a fluid to the control line 40 and recirculate the fluid that has passed through the battery cell 20. The fluid provided from the supply line 50 may be an inert gas such as nitrogen or helium.

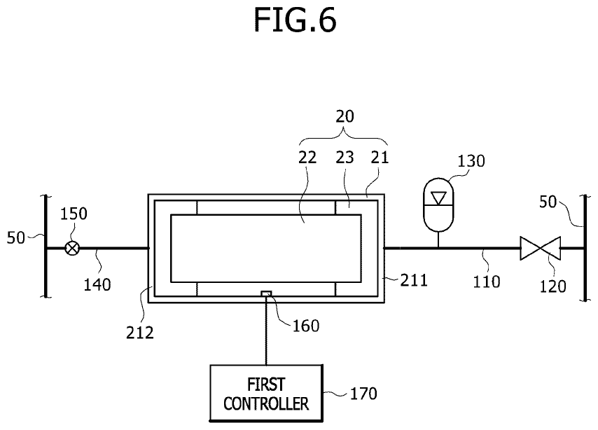

FIG. 6 is a view schematically illustrating a first embodiment of the control line 40 in FIG. 5. The control line 40 may include a supply flow path 110, a supply valve 120, and a storage unit 130.

The supply flow path 110 may connect the battery cell 20 and the supply line 50 and supply a fluid to the battery cell 20. The supply flow path 110 may connect a first side 211 of the can 21 and the supply line 50, so that the fluid provided from the supply line 50 may be supplied into the first side 211 of the can 21. The fluid supplied into the battery cell 20 may provide a uniform pressure to the electrode assembly 22.

The supply valve 120 may be formed on the supply flow path 110 and may control a supply amount of the fluid. The supply valve 120 may be disposed on the supply flow path 110 connecting the first side 211 and the supply line 50 to open and close the supply flow path 110.

The storage unit 130 may be connected to the supply flow path 110 and may temporarily store the fluid. The storage unit 130 may be disposed on the supply flow path 110 connecting the first side 211 and the supply valve 120. When the pressure of the fluid stored in the can 21 or the supply flow path 110 connecting the can 21 and the supply valve 120 exceeds a set pressure, the fluid may be introduced into the storage unit 130. In addition, when the pressure of the fluid stored in the can 21 or the supply flow path 110 connecting the can 21 and the supply valve 120 is lower than the set pressure, the fluid stored in the storage unit 130 may be discharged to the supply flow path 110.

In the above structure, when the supply valve 120 is opened and the fluid is supplied into the can 21 and the pressure thereof reaches the set pressure, the supply valve 120 closes the supply flow path 110. In addition, the fluid may be introduced into the storage unit 130 or flow out from the storage unit 130 depending on changes in internal pressure of the can 21 due to the expansion or contraction of the electrode assembly 22, so that a set pressure may be maintained in the can 21.

The control line 40 according to the first embodiment of the present disclosure may further include a discharge flow path 140 and a discharge valve 150.

The discharge flow path 140 may connect the battery cell 20 and the supply line 50 and discharge the fluid from the battery cell 20. The discharge flow path 140 may connect a second side 212 opposite to the first side 211 and the supply line 50 and guide the discharge of fluid supplied to the can 21.

The discharge valve 150 may be formed on the discharge flow path 140 and may control a fluid discharge amount. The discharge valve 150 may be disposed on the discharge flow path 140 connecting the second side 212 and the supply line 50. The discharge valve 150 may open the discharge flow path 140 when the discharge flow path 140 exceeds a set pressure.

When the storage unit 130 fails to relieve excessive fluid pressure, the above structure may maintain the set pressure in the electrode assembly 22 by discharging the fluid stored in the can 21 through the discharge valve 150.

The control line 40 according to the first embodiment of the present disclosure may further include a sensor 160 and a first controller 170.

The sensor 160 may detect the internal pressure of the battery cell 20. The sensor 160 may be mounted inside of the can 21 and may measure the pressure caused by the fluid being injected into the can 21.

The controller 170 may operate the supply valve 120 and the discharge valve 150 according to a detection signal from the sensor 160. That is, the controller 170 may receive the detection signal from the sensor 160 in real time and actively supply or discharge the fluid so that the internal pressure of the can 21 is uniform.

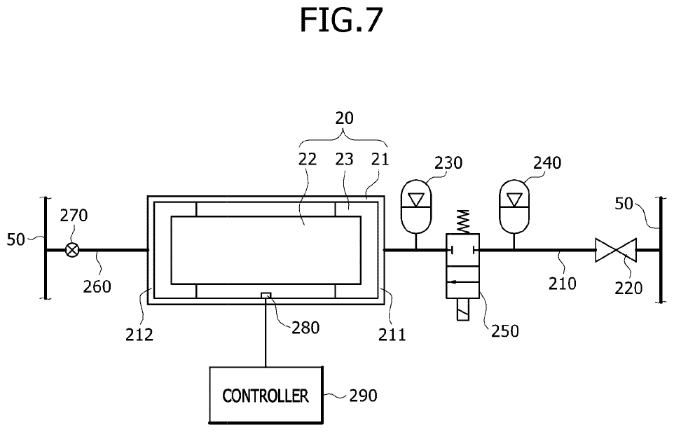

FIG. 7 is a view schematically illustrating a second embodiment of the control line in FIG. 5. In this embodiment, the control line 40 may include a supply flow path 210, a supply valve 220, a main storage unit 230, and a sub storage unit 240.

The supply flow path 210 may connect the battery cell 20 and the supply line 50 and supply a fluid to the battery cell 20. The supply flow path 210 may connect the first side 211 of the can 21 and the supply line 50, so that the fluid provided from the supply line 50 may be supplied to the first side 211 of the can 21. The fluid supplied into the battery cell 20 may provide a uniform pressure to the electrode assembly 22.

The supply valve 220 may be formed on the supply flow path 210 and may control a fluid supply amount. The supply valve 220 may be disposed on the supply flow path 210 connecting the first side 211 and the supply line 50 to open and close the supply flow path 210.

The main storage unit 230 may be formed on the supply flow path 210 and may temporarily store the fluid. The main storage unit 230 may be disposed on the supply flow path 210 between the first side 211 and the supply valve 220.

The sub storage unit 240 also may be formed on the supply flow path 210 and may temporarily store the fluid. The sub storage unit 240 may be disposed on the supply flow path 210 between the main storage unit 230 and the supply valve 220.

When the pressure of the fluid stored in the can 21, or the can 21 and the supply flow path 210, exceeds a set pressure, the fluid may be introduced into at least one of the main storage unit 230 and the sub storage unit 240. In addition, when the pressure of the fluid stored in the can 21 or the supply flow path 210 connected to the can 21 is lower than the set pressure, the fluid stored in at least one of the main storage unit 230 and the sub storage unit 240 may be discharged to the supply flow path 210. The main storage unit 230 may be disposed closer to the first side 211 than the sub storage unit 240 is to the first side 211.

In the structure depicted in FIG. 7, when the supply valve 220 is opened and the fluid is supplied into the can 21, and the pressure thereof reaches the set pressure, the supply valve 220 closes the supply flow path 210. In addition, the fluid may be introduced into at least one of the main storage unit 230 and the sub storage unit 240 or flow out from at least one of the main storage unit 230 and the sub storage unit 240 depending on changes in internal pressure of the can 21 due to expansion or contraction of the electrode assembly 22. Thus, a set pressure set may be maintained in the can 21.

The control line 40 according to the second embodiment of the present disclosure may further include an on-off valve 250. The on-off valve 250 may be formed on the supply flow path 210, may be disposed between the main storage unit 230 and the sub storage unit 240, and may open and close the supply flow path 210. The on-off valve 250 may open the supply flow path 210 so that the fluid in the sub storage unit 240 or the fluid supplied to the supply flow path 210 is supplied to the main storage unit 230 and the can 21.

Each of the main storage unit 230 and the sub storage unit 240 may be provided with a pressure sensor, and the on-off valve 250 may open the supply flow path 210 when the pressure of the fluid stored in the sub storage unit 240 is greater than the pressure of the fluid stored in the main storage unit 230. That is, when the supply valve 220 and the on-off valve 250 are opened and the initial fluid filling is completed, the supply valve 220 and the on-off valve 250 close the supply flow path 210. Then, the main storage unit 230 supplies the fluid stored therein to the can 21 to control the internal pressure of the can 21. When the pressure in the main storage unit 230 becomes lower than the pressure in the sub storage unit 240, the on-off valve 250 may open so that the fluid stored in the sub storage unit 240 is replenished in the main storage unit 230.

The control line 40 according to the second embodiment of the present disclosure may further include a discharge flow path 260 and a discharge valve 270.

The discharge flow path 260 may connect the battery cell 20 and the supply line 50 and discharge the fluid from the battery cell 20. The discharge flow path 260 may connect the second side 212 (opposite to the first side 211) and the supply line 50 and guide the fluid supplied to the can 21 to be discharged.

The discharge valve 270 may be formed on the discharge flow path 260 and may control the amount of fluid discharge. That is, the discharge valve 270 may be disposed on the discharge flow path 260 connecting the second side 212 and the supply line 50. The discharge valve 270 may open the discharge flow path 260 when the pressure in discharge flow path 260 exceeds a set pressure.

When the main storage unit 230 and the sub storage unit 240 fail to relieve excessive fluid pressure, the above structure may maintain the set pressure in the electrode assembly 22 by discharging the fluid stored in the can 21 through the discharge valve 270.

The control line 40 according to the second embodiment of the present disclosure may further include a sensor 280 and a controller 290.

The sensor 280 may detect the internal pressure of the battery cell 20. The sensor 280 may be mounted inside the can 21 and may measure the pressure caused by the fluid being injected into the can 21.

The controller 290 may operate the supply valve 220 and the discharge valve 270 according to a detection signal from the sensor 280. That is, the controller 290 may receive the detection signal from the sensor 280 in real time and actively supply or discharge the fluid so that the internal pressure of the can 21 is uniform. The controller 290 may directly control the on-off valve 250.

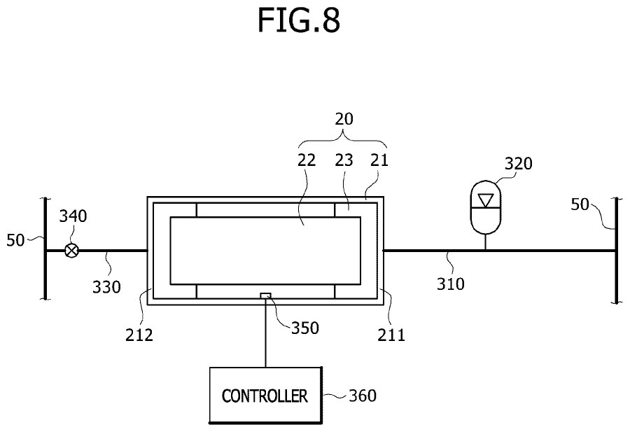

FIG. 8 is a view schematically illustrating a third embodiment of the control line in FIG. 5. The control line 40 according to the third embodiment of the present disclosure may include a supply flow path 310 and a storage unit 320.

The supply flow path 310 may connect the battery cell 20 and the supply line 50 and supply a fluid to the battery cell 20. The supply flow path 310 may connect the first side 211 of the can 21 and the supply line 50, so that the fluid provided from the supply line 50 may be supplied to the first side 211 of the can 21. The fluid supplied into the battery cell 20 may provide a uniform pressure to the electrode assembly 22.

A storage unit 320 may be connected to the supply flow path 310 and may temporarily store the fluid. The storage unit 320 may be disposed on the supply flow path 310 connecting the first side 211 and the supply line 50. When the pressure of the fluid stored in the can 21, or the supply flow path 310 connected to the can 21 and the supply line 50, exceeds a set pressure, the fluid may be introduced into the storage unit 320. In addition, when the pressure of the fluid stored in the can 21 or the supply flow path 310 connected to the can 21 is lower than the set pressure, the fluid stored in the storage unit 320 may be discharged to the supply flow path 310.

In the above structure, when the supply line 50 supplies the fluid and the pressure inside the can 21 reaches the set pressure, forced supply of the fluid through the supply line 50 is stopped. In addition, the fluid may be introduced into the storage unit 320 or flow out from the storage unit 320 depending on changes in internal pressure of the can 21 due to the expansion or contraction of the electrode assembly 22. Thus, a set pressure may be maintained in the electrode assembly 22.

The control line 40 according to the third embodiment of the present disclosure may further include a discharge flow path 330 and a discharge valve 340.

The discharge flow path 330 may connect the battery cell 20 and the supply line 50 and discharge the fluid from the battery cell 20. The discharge flow path 330 may connect the second side 212 (opposite to the first side 211) and the supply line 50 and guide the fluid discharge from the can 21.

The discharge valve 340 may be formed on the discharge flow path 330 and may control the fluid discharge amount. That is, the discharge valve 340 may be disposed on the discharge flow path 330 connecting the second side 212 and the supply line 50. The discharge valve 340 may open the discharge flow path 330 when the discharge flow path 330 exceeds a set pressure.

When the storage unit 320 fails to relieve excessive fluid pressure, the above structure may maintain the set pressure in the electrode assembly 22 by discharging the fluid stored in the can 21 through the discharge valve 340.

The control line 40 according to the third embodiment of the present disclosure may further include a sensor 350 and a controller 360.

The sensor 350 may detect the internal pressure of the battery cell 20. The third sensor 350 may be mounted inside the can 21 and may measure the pressure caused by the fluid being injected into the can 21.

The third controller 360 may operate the discharge valve 340 according to a detection signal from the sensor 350. That is, the third controller 360 may receive the detection signal from the sensor 350 in real time and actively discharge the fluid so that the internal pressure of the can 21 is uniform. The controller 360 may directly control the supply line 50 so that fluid is actively supplied.

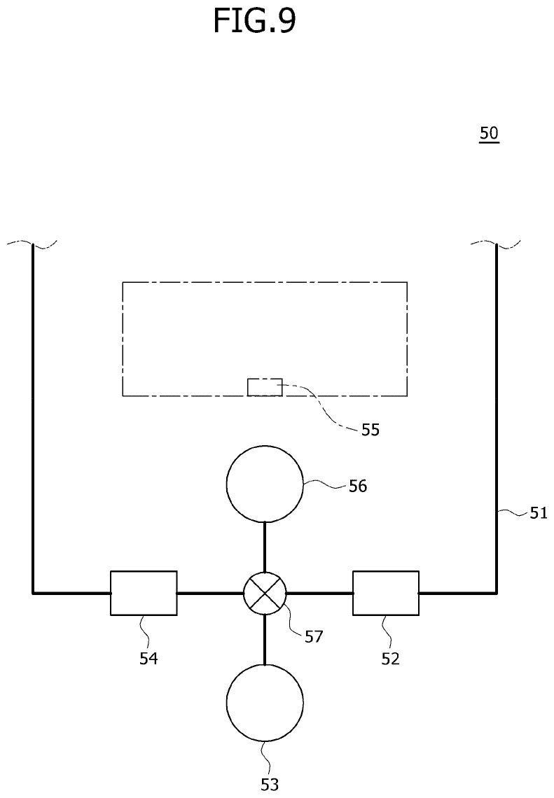

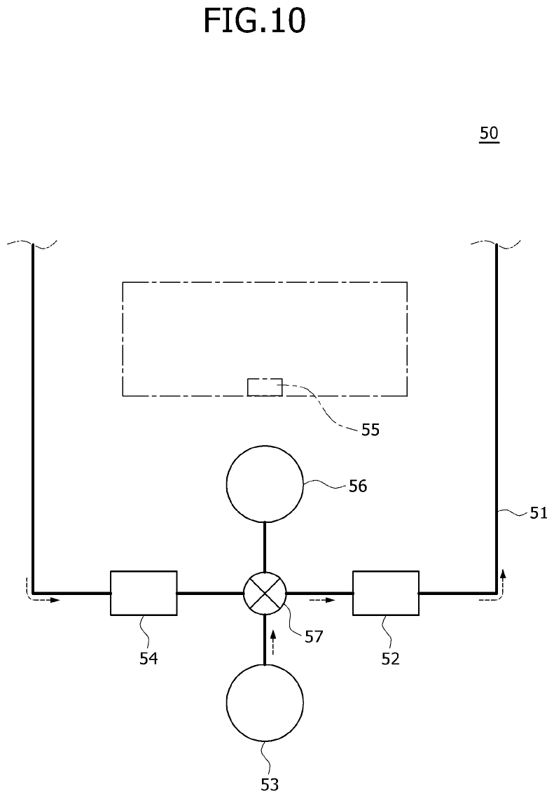

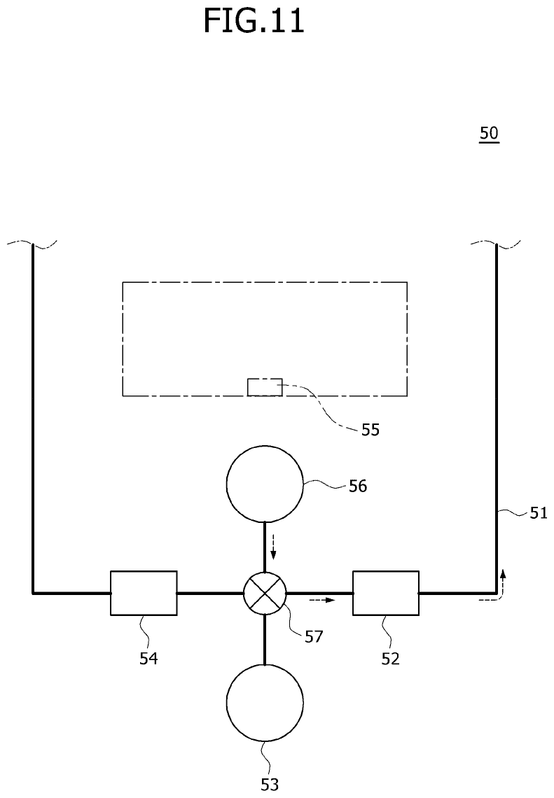

FIG. 9 is a view schematically illustrating the supply line according to one embodiment of the present disclosure, FIG. 10 is a view schematically illustrating a movement path of a fluid, and FIG. 11 is a view schematically illustrating a movement path of a fire extinguishing agent. The supply line 50 may include a supply flow path 51, a supply pump 52, and a supply tank 53.

The supply flow path 51 may have both ends connected to the control line 40 to circulate the fluid. The control line 40 may be connected to the first side 211 and the second side 212 of each can 21, and the supply flow path 51 may be connected to each control line 40.

The supply pump 52 may be formed on the supply flow path 51 and may discharge the fluid. The supply pump 52 may be a pump for pumping the fluid when powered on and may be driven by a motor.

The supply tank 53 may be formed on the supply flow path 51 and may store the fluid. The supply tank 53 may have a flow path connected to the supply flow path 51, and a valve is provided on the flow path to open and close the flow path. In addition, when the supply flow path 51 itself is filled with the fluid, the supply tank 53 may be omitted.

The supply line 50 may further include a supply cooler 54. The supply cooler 54 may be formed on the supply flow path 51 and may cool the fluid. The fluid cooled by the supply cooler 54 may be supplied to the can 21 to prevent overheating of the electrode assembly 22.

The supply line 50 may further include a fire detector 55 and a fire extinguishing agent supply unit 56. The fire detector 55 may detect a fire inside the battery cell 20. In particular, the fire detector 55 may be disposed inside the can 21 to detect flames or heat. A fire extinguishing agent supply unit 56 may be connected to the supply flow path 51 and may supply the fire extinguishing agent according to a detection signal from the fire detector 55. In the fire extinguishing agent supply unit 56, a space for storing the fire extinguishing agent may be formed, a flow path connected to the supply flow path 51 may be provided, and a valve may be provided on the flow path to open and close the flow path.

The supply line 50 may further include a selection valve 57. The selection valve 57 may be formed on the supply flow path 51 and may selectively supply the fluid provided from the supply tank 53 or the fire extinguishing agent provided from the fire extinguishing agent supply unit 56 to the supply flow path 51. The selection valve 57 may be a four-way valve connecting a flow path of the supply tank 53 and a flow path of the fire extinguishing agent supply unit 56. The selection valve 57 may open the supply flow path 51 to allow the fluid to be circulated through the supply flow path 51 as needed. The selection valve 57 may communicate the supply flow path 51 and the supply tank 53 so that the fluid stored in the supply tank 53 is replenished as needed. The selection valve 57 may communicate the supply flow path 51 and the fire extinguishing agent supply unit 56 so that the fire extinguishing agent stored in the fire extinguishing agent supply unit 56 is introduced into the can 21 through the supply flow path 51 as needed.

Referring to FIG. 10, when the fluid is supplied to the supply flow path 51 through the supply tank 53, the supply pump 52 is driven to supply the fluid into each can 21 of the battery cells 20 of the battery module 1. When the pressure of the fluid supplied into each can 21 increases and the fluid is discharged from the can 21, the fluid may be cooled in the supply cooler 54 and then reintroduced into the can 21.

Referring to FIG. 11, when a fire occurs due to overheating inside of a battery cell 20, the fire detector 55 may detect the fire, and the fire extinguishing agent supplied from the fire extinguishing agent supply unit 56 may be supplied into the can 21 along a flow path. Thus, the fire extinguishing agent is guided to the battery cell 20 to extinguish the fire.

While the present disclosure has been described with reference to embodiments shown in the drawings, these embodiments are merely illustrative and it should be understood that various modifications and equivalent other embodiments can be derived by those skilled in the art on the basis of the embodiments.

Therefore, the technical scope of the present disclosure should be defined by the appended claims.

What is claimed is:

1. A battery module comprising:
a housing;
a plurality of battery cells disposed inside the housing; and
a pressure regulator configured to control an internal pressure of each of the plurality of battery cells.

2. The battery module as recited in claim 1, wherein each of the battery cells includes:
a can;
an electrode assembly disposed inside the can and spaced apart from an inner surface of the can; and
a fixed guide supporting the electrode assembly.

3. The battery module as recited in claim 2, wherein the fixed guide includes a fixed pad attached to an inner wall of the can to support the electrode assembly, the fixed pad including an elastic material.

4. The battery module as recited in claim 2, wherein the fixed guide includes:
a fixed spring mounted on an inner wall of the can and having elasticity; and
a fixed holder supported by the fixed spring and holding the electrode assembly.

5. The battery module as recited in claim 1, wherein the pressure regulator includes:
a control line connected to each of the battery cells to control the internal pressure of each of the battery cells; and
a supply line connected to the control lines to supply a fluid.

6. The battery module as recited in claim 5, wherein each of the control lines includes:
a supply flow path connecting the battery cell and the supply line and configured to supply the fluid to the battery cell;
a supply valve formed on the supply flow path and configured to control a supply amount of the fluid; and
a storage unit connected to the supply flow path and configured to temporarily store the fluid.

7. The battery module as recited in claim 6, wherein each of the control lines further includes:
a discharge flow path connecting the battery cell and the supply line and configured to discharge the fluid from the battery cell; and
a discharge valve formed on the discharge flow path and configured to control a fluid discharge amount.

8. The battery module as recited in claim 7, wherein each of the control lines further includes:
a sensor configured to detect the internal pressure of the battery cell; and
a controller configured to operate the supply valve and the discharge valve according to a detection signal from the sensor.

9. The battery module as recited in claim 5, wherein each of the control lines includes:
a supply flow path connecting the battery cell and the supply line and configured to supply the fluid to the battery cell;
a supply valve formed on the supply flow path and configured to control a supply amount of the fluid;
a main storage unit formed on the supply flow path and configured to temporarily store the fluid; and
a sub storage unit formed on the supply flow path, configured to temporarily store the fluid, and disposed between the main storage unit and the supply valve.

10. The battery module as recited in claim 9, wherein the control line further includes an on-off valve formed on the supply flow path, disposed between the main storage unit and the sub storage unit, and configured to open and close the supply flow path.

11. The battery module as recited in claim 10, wherein the on-off valve opens the supply flow path when a pressure of the fluid stored in the sub storage unit is greater than a pressure of the fluid stored in the main storage unit.

12. The battery module as recited in claim 9, wherein each of the control lines further includes:
a discharge flow path connecting the battery cell and the supply line and configured to discharge the fluid from the battery cell; and
a discharge valve formed on the discharge flow path and configured to control a fluid discharge amount.

13. The battery module as recited in claim 12, wherein each of the control lines further includes:
a sensor configured to detect the internal pressure of the battery cell; and
a controller configured to operate the supply valve and the discharge valve according to a detection signal from the sensor.

14. The battery module as recited in claim 5, wherein each of the control lines includes:
a supply flow path connecting the battery cell and the supply line and configured to supply the fluid to the battery cell; and
a storage unit connected to the supply flow path and configured to temporarily store the fluid.

15. The battery module as recited in claim 14, wherein each of the control lines further includes:
a discharge flow path connecting the battery cell and the supply line and configured to discharge the fluid from the battery cell; and
a discharge valve formed on the discharge flow path and configured to control a fluid discharge amount.

16. The battery module as recited in claim 15, wherein the control line further includes:
a sensor configured to detect the internal pressure of the battery cell; and
a controller configured to operate the discharge valve according to a detection signal from the sensor.

17. The battery module as recited in claim 5, wherein the supply line includes:
a supply flow path having ends connected to each of the control lines to circulate the fluid;
a supply pump formed on the supply flow path and configured to discharge the fluid; and
a supply tank formed on the supply flow path and configured to store the fluid.

18. The battery module as recited in claim 17, wherein the supply line further includes a supply cooler formed on the supply flow path and configured to cool the fluid.

19. The battery module as recited in claim 17, wherein the supply line includes:
a fire detector configured to detect a fire inside the battery module; and
a fire extinguishing agent supply unit connected to the supply flow path and configured to supply a fire extinguishing agent according to a detection signal from the fire detector.

20. The battery module as claimed in claim 19, wherein the supply line further includes a selection valve formed on the supply flow path and configured to selectively supply the fluid provided from the supply tank and the fire extinguishing agent provided from the fire extinguishing agent supply unit to the supply flow path.
